(19) United States
(12) Patent Application Publication
(10) Pub. No.: US 2019/0268177 A1
(43) Pub. Date: Aug. 29, 2019

(54) WIRELESS INTERNET OF THINGS, CLIMATE CONTROL AND SMART HOME SYSTEM

(71) Applicant: Tri Cascade, Inc., Newport Beach, CA (US)

(72) Inventor: Max Chin Li, Newport Beach, CA (US)

(21) Appl. No.: 16/286,516

(22) Filed: Feb. 26, 2019

Related U.S. Application Data
(60) Provisional application No. 62/635,447, filed on Feb. 26, 2018.
(60) Provisional application No. 62/651,574, filed on Apr. 2, 2018.
(60) Provisional application No. 62/724,578, filed on Aug. 29, 2018.

(51) Int. Cl. H04L 12/28; G10L 15/22; G10L 15/30; G06N 20/00

(52) U.S. Cl. CPC H04L 12/2834; H04L 12/2814; G10L 15/22; G10L 2015/223; G06N 20/00; H04L 2012/2841; G10L 15/30

(57) ABSTRACT

Systems and methods for an Internet of Things (IoT), smart home climate control and communication system are provided. The IoT, smart home climate control and communication system includes a first smart home device that receives signal sources from a wide area network, transmits signals, data and commands to one or more smart home devices in a home or building in an IoT LAN. The first smart home device also receives signals, data and commands from the one or more smart home devices in the home or building on the IoT LAN, and transmits signals, data and/or commands to the wide area network. The IoT LAN is distinct from a residential wireless LAN.

### CROSS REFERENCE TO RELATED APPLICATIONS

This application claims priority under 35 U.S.C. § 119(e) to U.S. Provisional Application No. 62/635,447, filed Feb. 26, 2018, U.S. Provisional Application No. 62/651,574, filed Apr. 2, 2018 and U.S. Provisional Application No. 62/724,578, filed Aug. 29, 2018, the disclosures of which are incorporated herein by reference in their entireties for all purposes.

### TECHNICAL FIELD

The present disclosure generally relates to a smart home system, and more particularly, to a smart home wireless Internet of Things (IoT), climate control, and communication system which can be remotely controlled and operated to provide whole premise, wireless Internet of Things, climate control, and communication functions. The smart home communication system also includes a smart voice switch that can receive voice input and communicate with other various devices of the smart home system.

### BACKGROUND

Current commercially available smart home devices, sometimes also known as Internet of Things (IoT) home devices, include various smart home devices that can be controlled remotely using a smart phone or a computing device. However, these home devices operate independently, and it can be inconvenient or even impossible to interact with these smart home devices when the user does not conveniently have in possession a smart phone or a computing device.

A need therefore exists for an integrated wireless IoT smart home system that includes a smart voice assistant device that can receive voice input and communicate with other various devices of the smart home system, including with climate control and communication system that includes a hub, or center, through which a user can remotely control and wirelessly operate a plurality of devices, and that further provides communications, and advantages heretofore unknown in the art.

### SUMMARY OF THE INVENTION

An Internet of Things (IoT), smart home climate control and communication system is provided. The IoT, smart home climate control and communication system of the present disclosure may also be referred to herein as the IoT, climate control and communication system, or IoT communication system for brevity. The IoT, climate control and communication system may generally include a first smart home device, for example a home gateway or a smart thermostat, that may receive signal sources from a wide area network, for example, the Internet or a cellular network, and transmit signals, data and commands to one or more home devices (e.g., smart devices, geographical zone devices, sensors, etc.) in a home or building. The first smart home device may also receive signals, data and commands from the one or more home devices in the home or building and the transmit signals, data and/or commands to the wide area network. In some embodiments, the home devices in the home or building may include televisions (TVs), data modem, repeater, cameras, appliances, lighting units, voice units, garage units, zone devices for controlling heating, venting and/or air conditioning (“HVAC”) units, smart dimmer switch, smart outlet, and so on. In some embodiments, the signals received by and transmitted from the home gateway are wireless signals. The first smart home device connect wirelessly to the wide area network and to a first wireless local area network, wherein the wide area network may be a cellular network and the first wireless local area network is distinct from a second wireless local area network, which may be a residential consumer Wi-Fi network. In this set up, even if the home or building loses the residential Wi-Fi network, the first smart home device can still connect to and communicate with the plurality of smart home devices on the first local area network. This feature of the present disclosure is a technical improvement in home networking and smart home communication.

In some embodiments, the first smart home device may comprise a Subscriber Identity Module (SIM) card and a Wi-Fi controller. With a SIM card, the first smart home device can connect directly to a cellular network, for example without an intermediate modem. With a Wi-Fi controller, the first smart home device can act as Wi-Fi router. This feature of the present disclosure is yet another technical improvement among other technical improvements in home networking and smart home communication disclosed herein.

In some embodiments, the zone devices, which may be wall plug devices, may include temperature sensor to detect the temperature of a geographic area (or zone) within a residence or a business or commercial facility. In some embodiments, a zone device manages the HVAC system(s) within its zone.

In some embodiments, the first smart home device may be a smart thermostat. In other embodiments, the first smart home device may be or may include a home gateway. The may receive TV broadcast signals from TV broadcast stations or head-ends, convert the signals and transmit the converted signals for displayed at TV sets.

In some embodiments, the home gateway may receive broadband data signals from an Internet Service Provider (ISP), convert the signals and transmit the converted signals to a router, for example, an Ethernet router.

In some embodiments, the home gateway may provide 24/7 redundancy failover Internet connection. The home gateway may be connected to a cable/DSL modem and subscribe to a cellular Internet data service at the same time. When the home gateway detects that the cable/DSL has disconnected with the Internet, the home gateway may switch over to the cellular Internet immediately and automatically, to ensure that the household or building will have Internet network connection. The home gateway may similarly switch to the cable/DSL connection when it detects failure on the cellular connection.

In some embodiments, the home gateway may be connected to a consumer tablet, such as an iPad™, to leverage unlimited and rich apps used for many different applications.

In some embodiments, the home gateway may also integrate with an artificial intelligence system, to provide functionalities such as indicating the system (home gateway) status, network status, climate or air quality condition, smoke alert, any add-on function of sensor capability, etc.

In some embodiments, the home gateway may provide a mesh network to the house and building for a better, more robust wireless network connection.

In some embodiments, the IoT, climate control and communication system may further include a voice assistant unit that may receive voice input from a user and communicate with other various devices of the smart home system, including with the home gateway. The voice input may include commands to control the various devices. For example, the voice assistant unit may control home climate by receiving voice input and communicate with a smart thermostat. The voice assistant unit may communicate with other smart devices directly, or via the home gateway. The communication may be wired or wireless, e.g., via LAN, Wi-Fi, etc. The voice assistant unit may be referred to herein as an Intelligent Voice Assistant.

Other devices, apparatus, systems, methods, features and advantages of the disclosure will be or will become apparent to one with skill in the art upon examination of the following figures and detailed description. It is intended that all such additional systems, methods, features and advantages be included within this description, and be protected by the accompanying claims.

### BRIEF DESCRIPTION OF THE FIGURES

The present disclosure may be better understood by referring to the following figures. The components in the figures are not necessarily to scale, emphasis instead being placed upon illustrating the principles of the disclosure. In the figures, like reference numerals designate corresponding parts throughout the different views.

FIG. 1A illustrates a diagram with supported devices in an IoT, climate control, and communication system, according to the teachings of the present disclosure.

FIG. 1B illustrates a diagram with more supported devices in an IoT, climate control, and communication system configuration, according to the teachings of the present disclosure.

FIG. 1B-1 illustrates a diagram of an IoT, climate control, and communication system configuration having an intelligent voice assistant device in a house, according to the teachings of the present disclosure.

FIG. 1B-2 illustrates a simplified diagram of an IoT, climate control, and communication system configuration having an intelligent voice assistant device using a router or gateway, according to the teachings of the present disclosure.

FIG. 1B-3 illustrates a simplified diagram of an IoT, climate control, and communication system configuration using a portable voice device, according to the teachings of the present disclosure.

FIG. 1C illustrates a system view of one exemplary embodiment of an IoT, climate control, and communication system having different zones, according to the teachings of the present disclosure.

FIG. 1D illustrates an exemplary user interface for smart home devices supported by the IoT, climate control, and communication system, according to the teachings of the present disclosure.

FIG. 1E-1 illustrates an exemplary smart thermostat of the IoT, climate control, and communication system, according to the teachings of the present disclosure.

FIG. 1E-2 illustrates an exemplary high-level schematic diagram of a smart thermostat of the IoT, climate control, and communication system, according to the teachings of the present disclosure.

FIG. 1E-3 illustrates an exemplary Wi-Fi IoT network in a house, according to the teachings of the present disclosure.

FIG. 1F illustrates an exemplary view of a wall box for a Smart Touch Dimmer, also referred herein as Smart Switch or Smart IoT Voice Light Switch, according to the teachings of the present disclosure.

FIG. 1G illustrates an exemplary voice command connection and operation among a home gateway, a smart voice light switch, a smart IoT thermostat, and a cloud management system, according to the teachings of the present disclosure.

FIG. 1H illustrates an exemplary voice command connection of FIG. 1G using a mobile voice command, according to the teachings of the present disclosure.

FIG. 1I illustrates an exemplary front view of an intelligent voice assistant device, according to the teachings of the present disclosure.

FIG. 1J illustrates an exemplary high-level block diagram of a smart home system having an intelligent voice assistant device, according to the teachings of the present disclosure.

FIG. 1K illustrates an exemplary high-level block diagram of a smart home system having an intelligent voice assistant device coupled to a home management device, according to the teachings of the present disclosure.

FIG. 1L illustrates an exemplary list of features and components of an intelligent voice assistant device, according to the teachings of the present disclosure.

FIG. 1M illustrates an exemplary high-level block diagram of hardware components of an intelligent voice assistant device, according to the teachings of the present disclosure.

FIG. 1N illustrates an exemplary front view on a wall-mount smart home camera device of the smart home, according to the teachings of the present disclosure.

FIG. 2 illustrates a front perspective view of an exemplary home gateway, according to the teachings of the present disclosure.

FIG. 3 illustrates a rear perspective view of an exemplary home gateway, according to the teachings of the present disclosure.

FIG. 4 illustrates a front view of an exemplary home gateway, according to the teachings of the present disclosure.

FIG. 5 illustrates a rear view of an exemplary home gateway, according to the teachings of the present disclosure.

FIG. 6 illustrates a left side view of an exemplary home gateway, according to the teachings of the present disclosure.

FIG. 7 illustrates a right side view of an exemplary home gateway, according to the teachings of the present disclosure.

FIG. 8 illustrates a top view of an exemplary home gateway, according to the teachings of the present disclosure.

FIG. 9 illustrates a bottom view of an exemplary home gateway, according to the teachings of the present disclosure.

FIGS. 10A and 10B illustrate perspective views of the exemplary home gateway receiving a mobile device, according to the teachings of the present disclosure.

FIG. 11A illustrates a schematic view of some of the electronics of an exemplary home gateway, according to the teachings of the present disclosure.

FIG. 11B illustrates a schematic view of a processor of an exemplary home gateway, according to the teachings of the present disclosure.

FIG. 11C an exemplary process chart of an IoT, climate control, and communication system, according to teachings of the present disclosure

FIG. 12 illustrates an exemplary process of an IoT, climate control, and communication system, according to teachings of the present disclosure.

### DETAILED DESCRIPTION

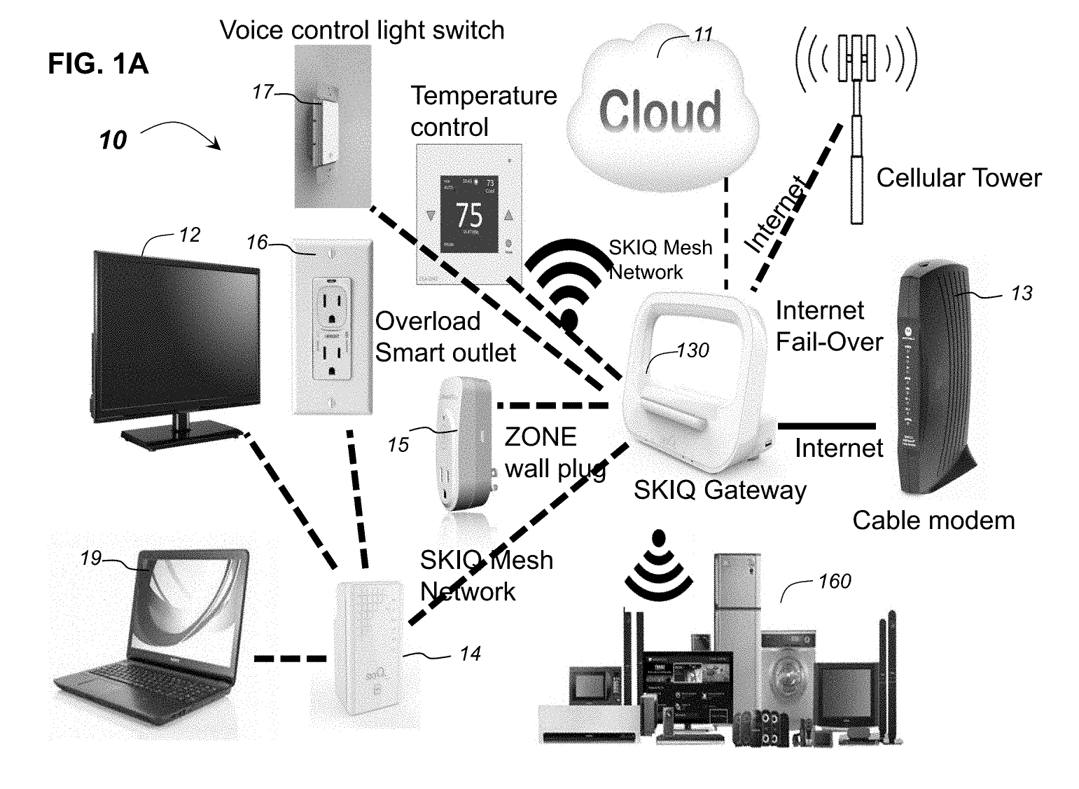

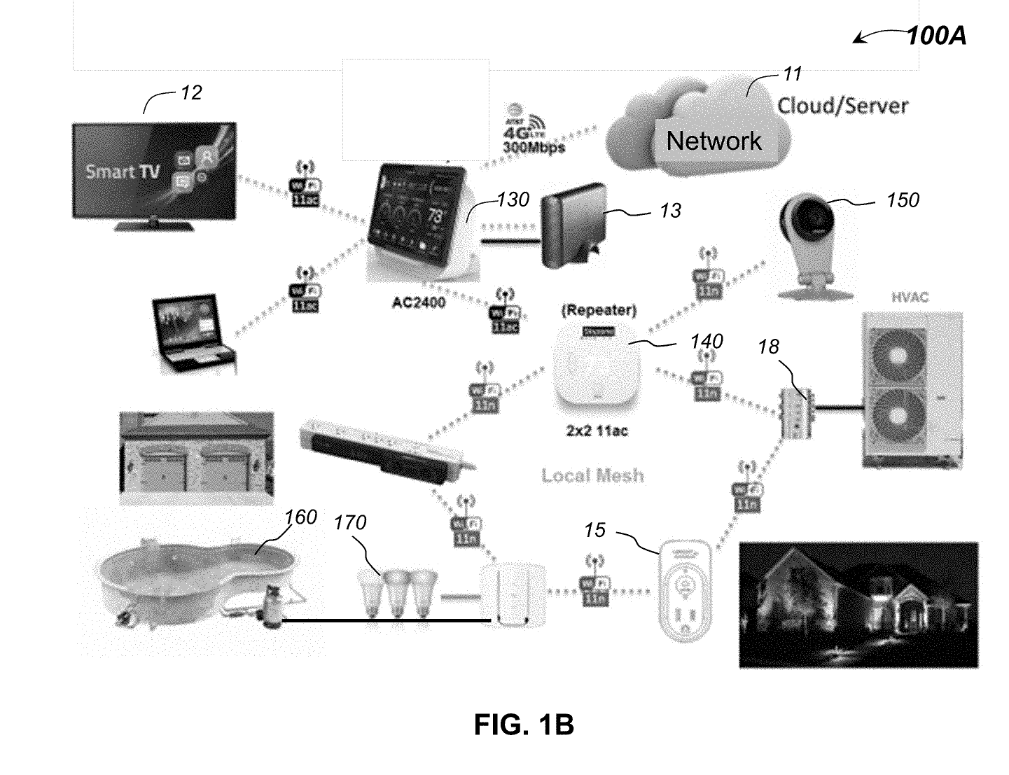

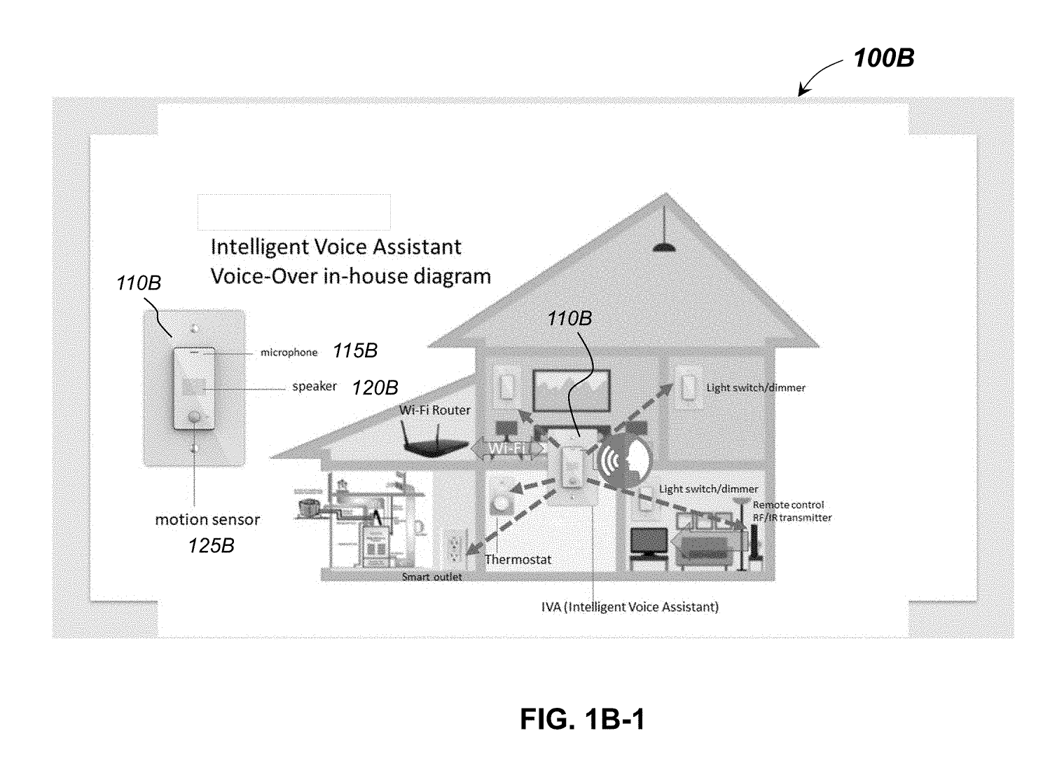

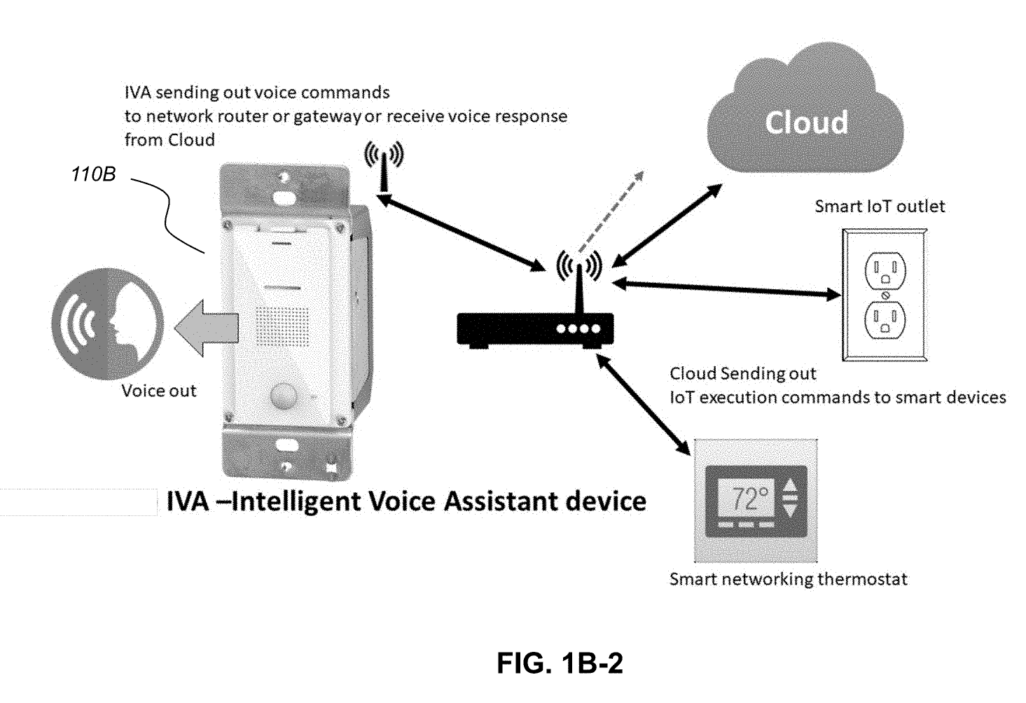

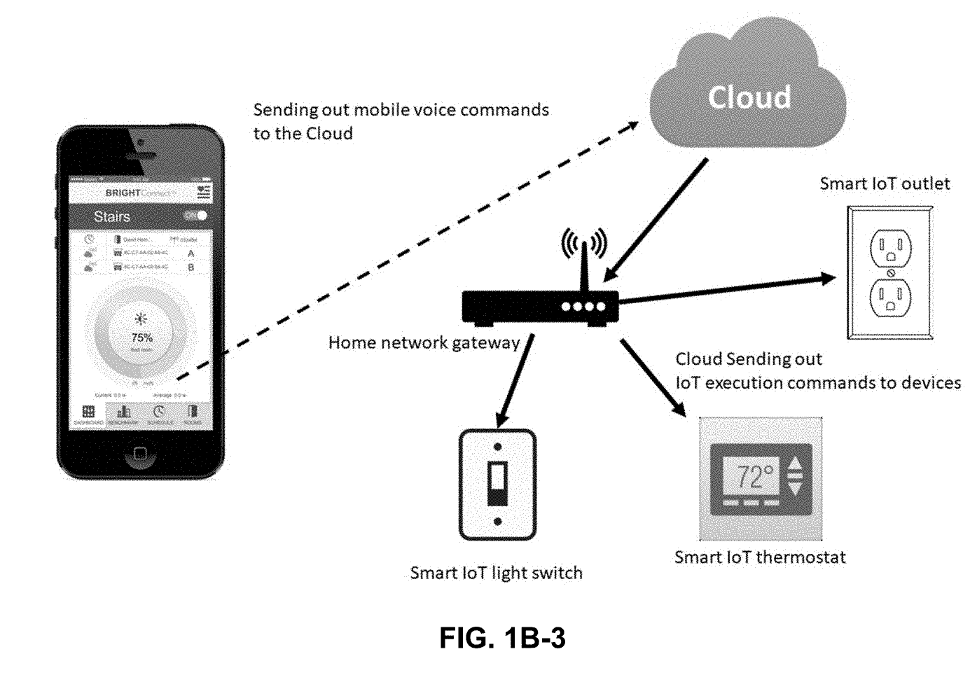

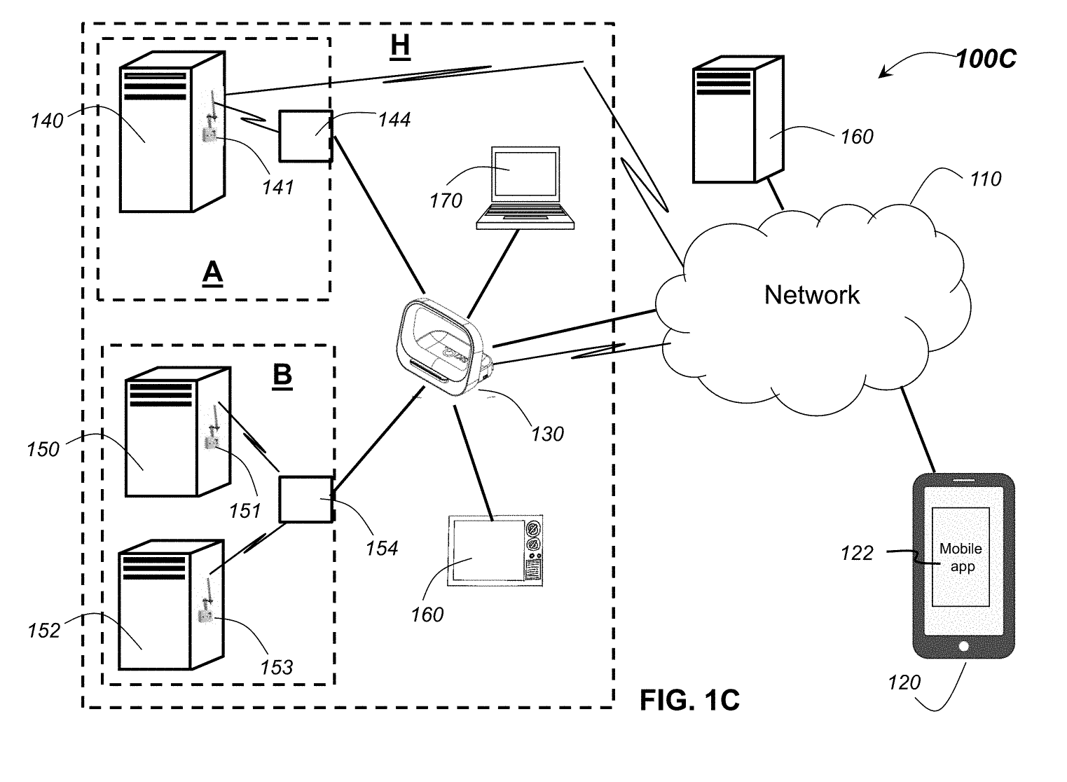

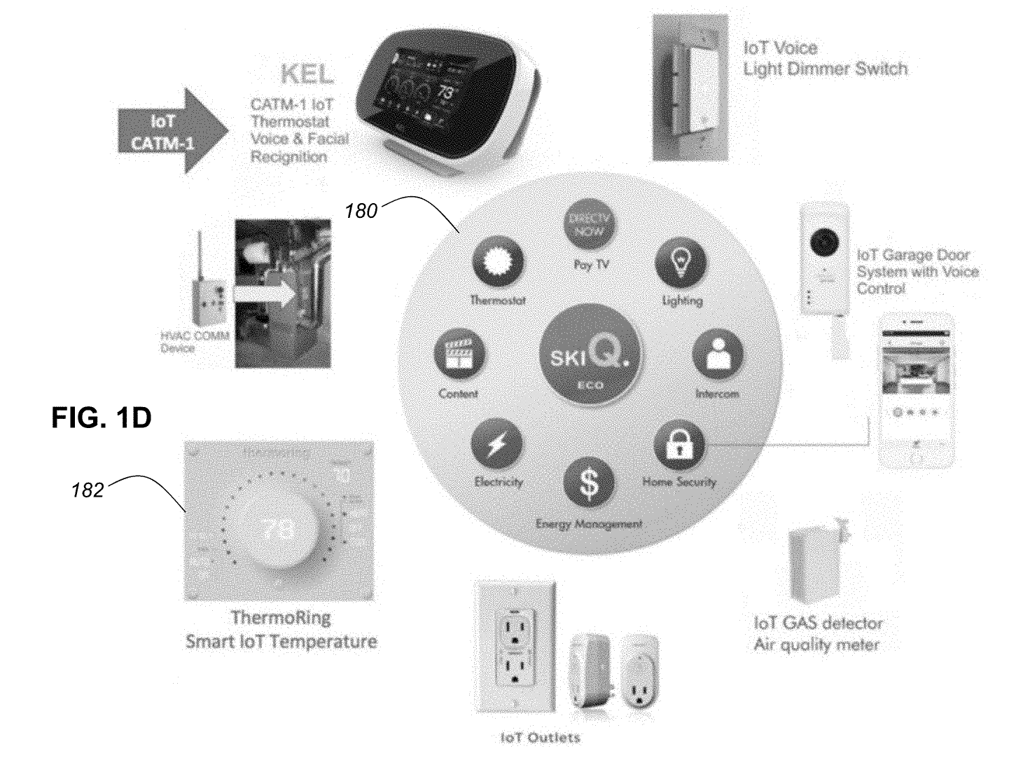

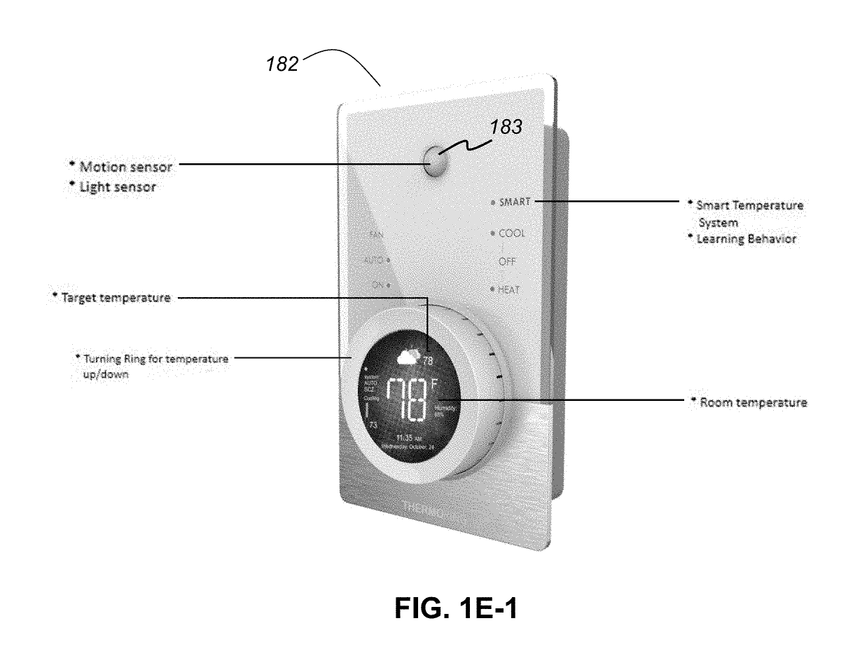

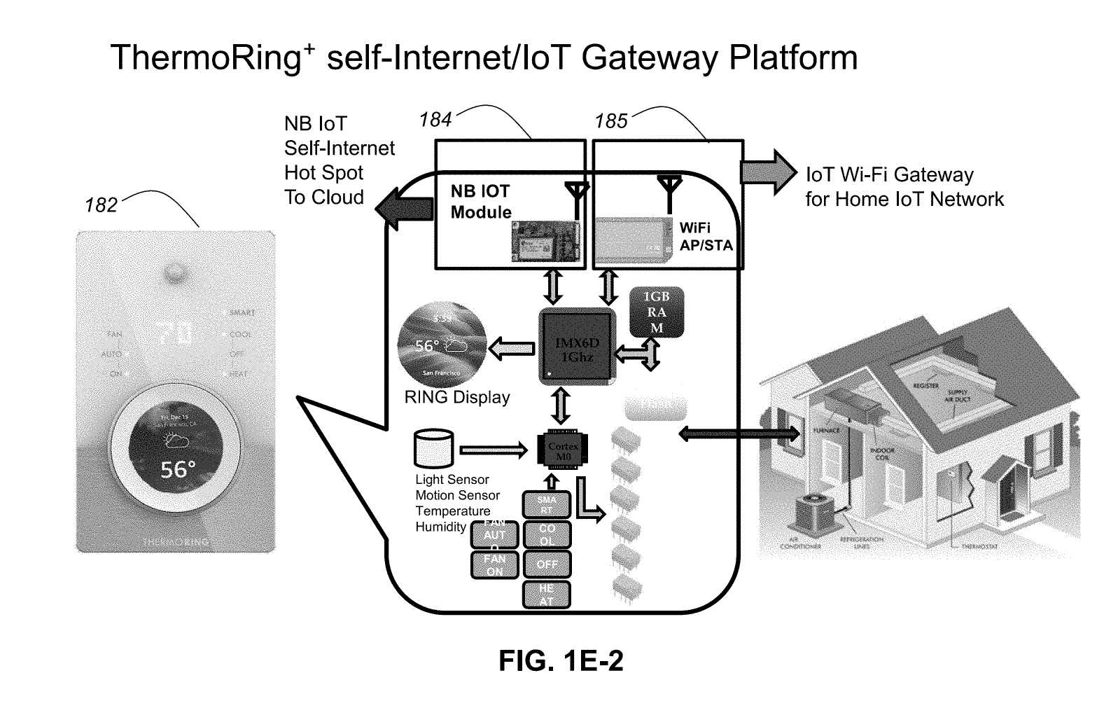

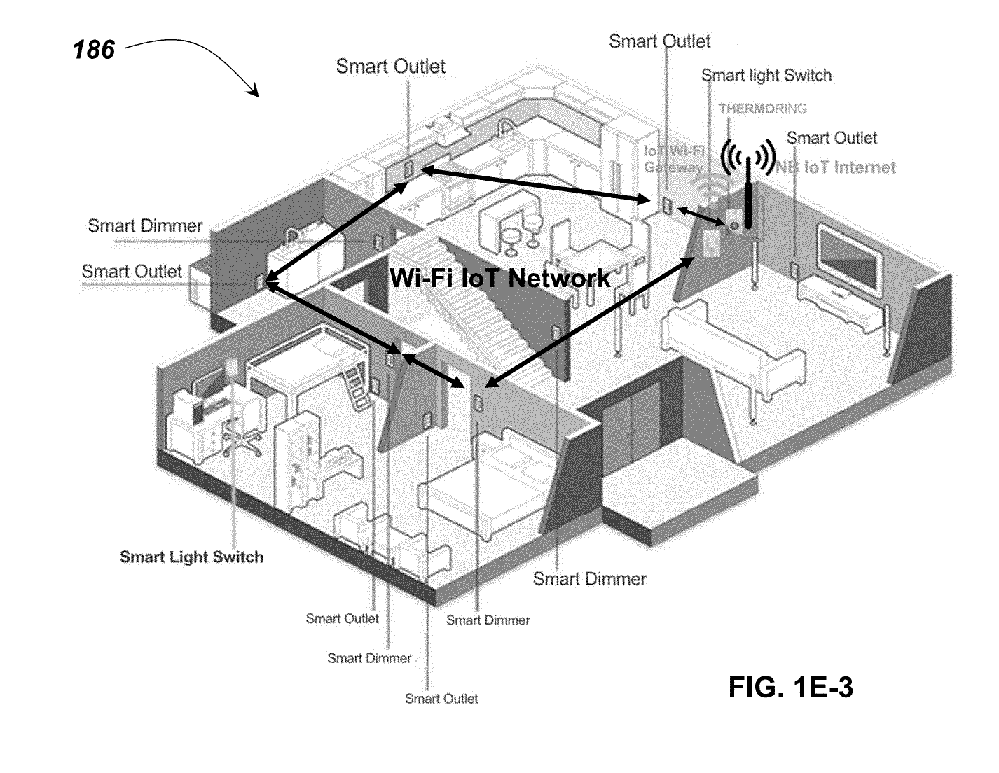

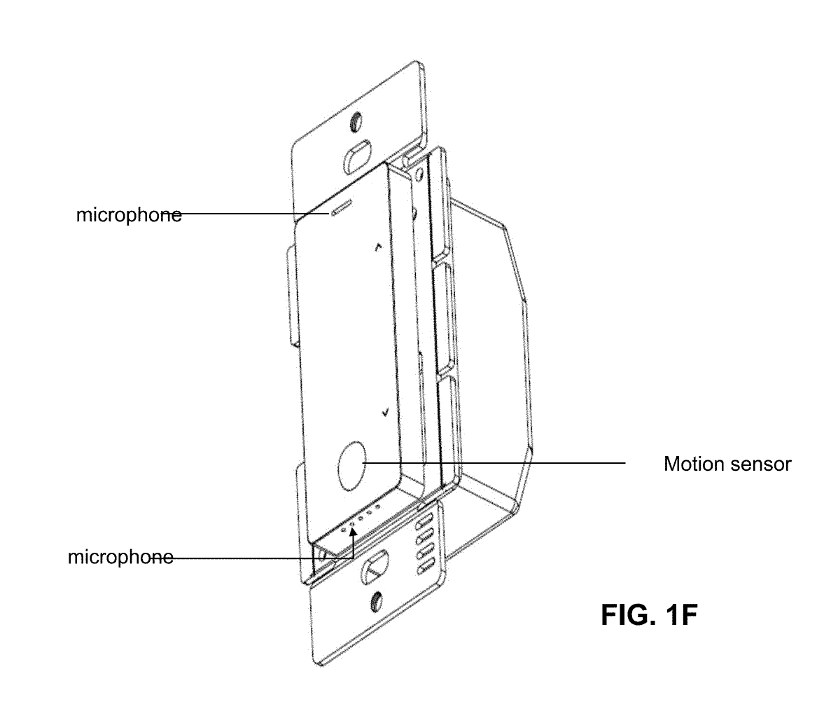

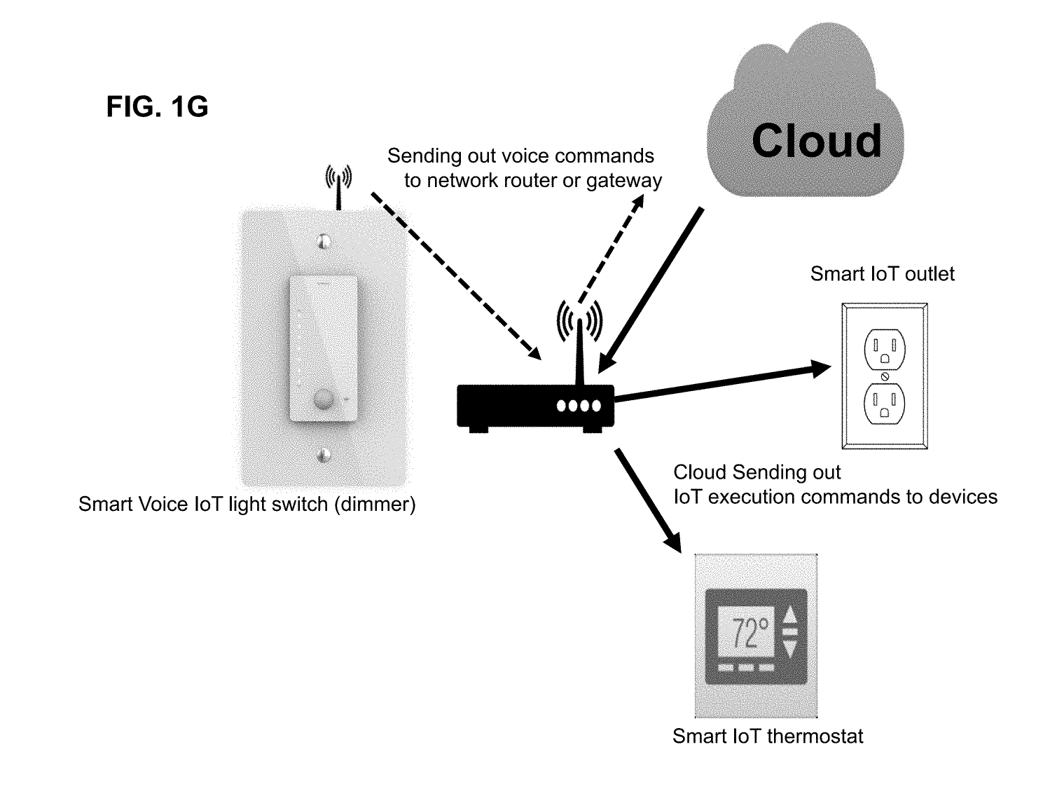

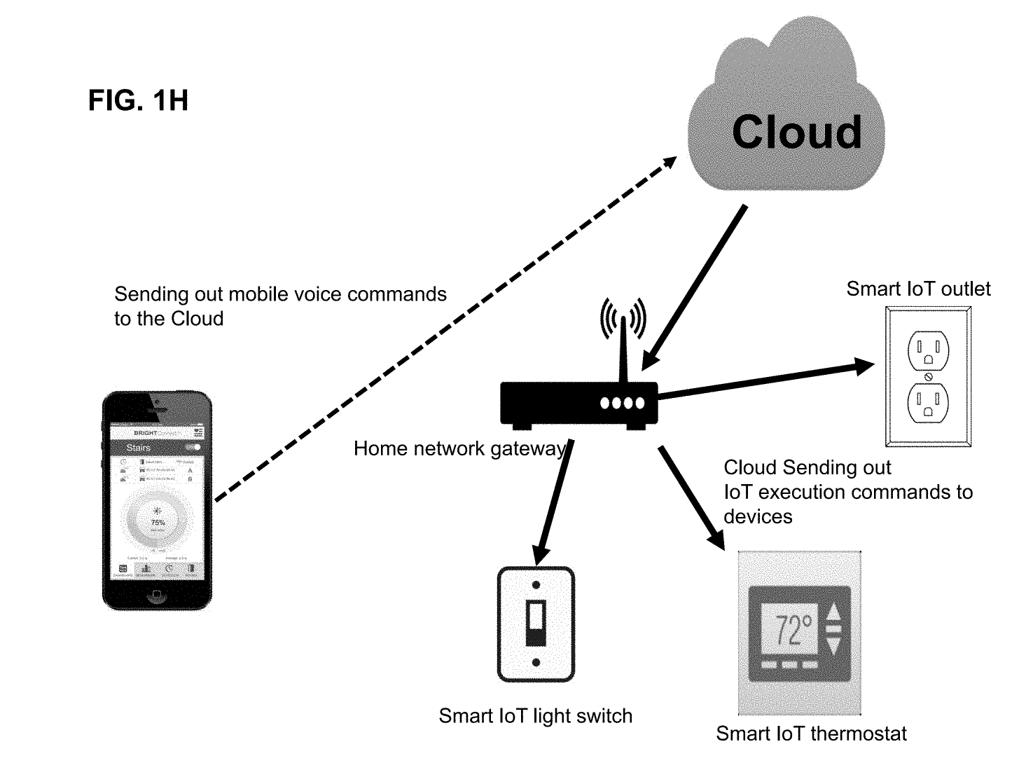

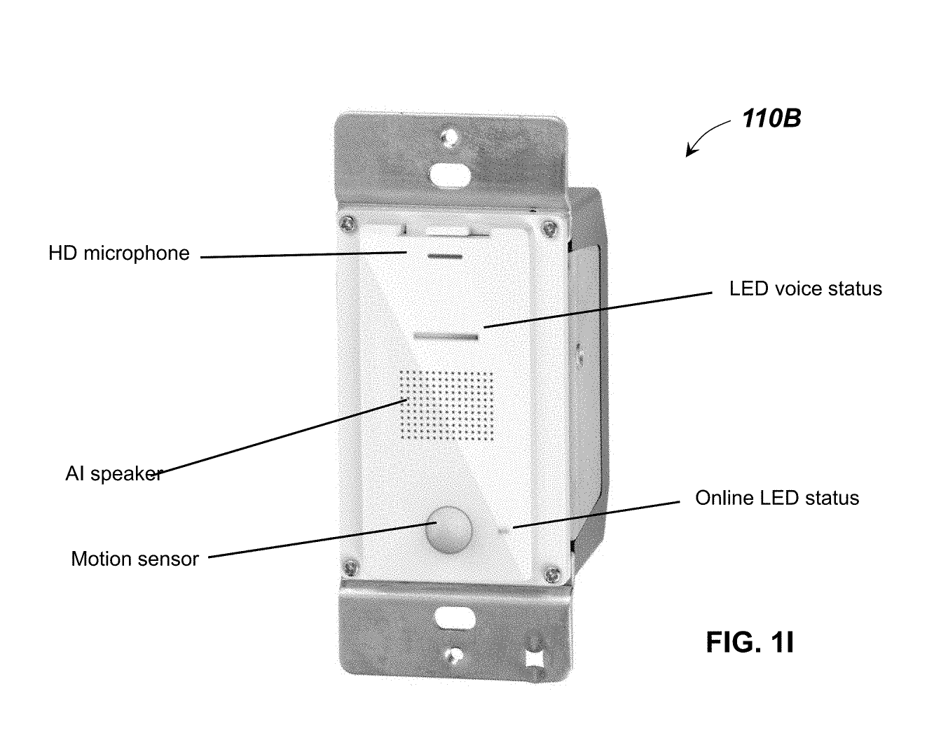

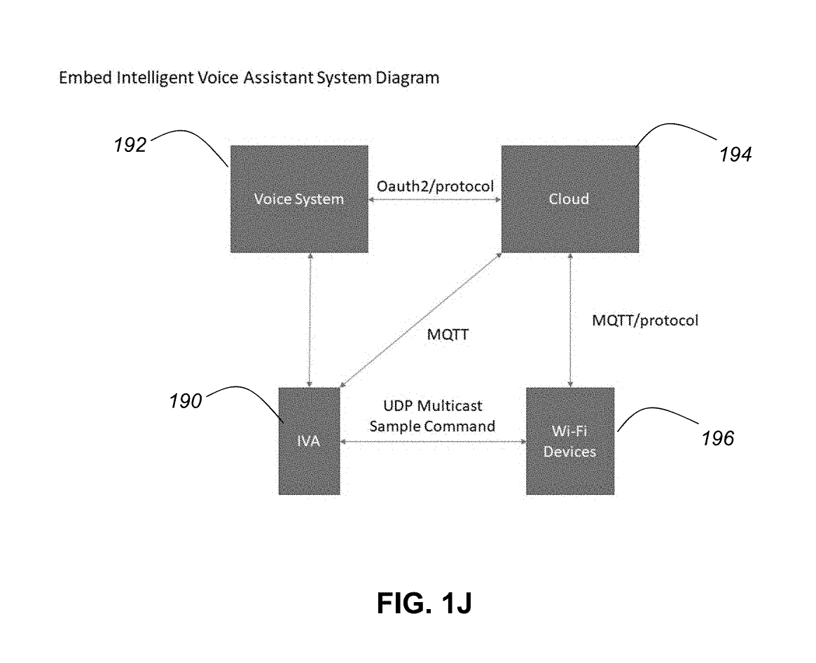

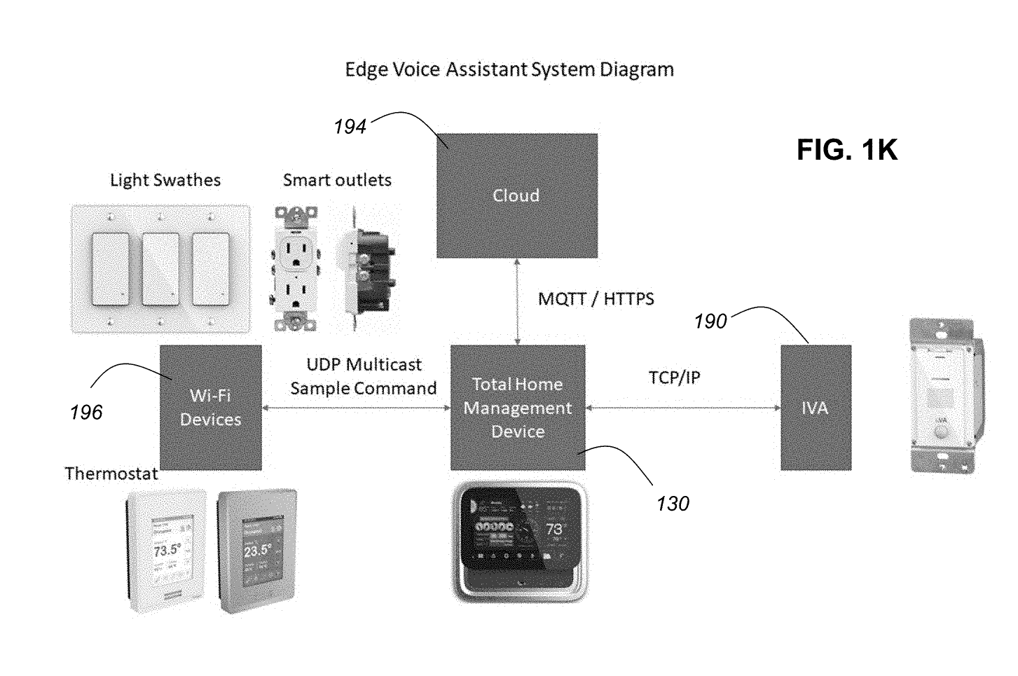

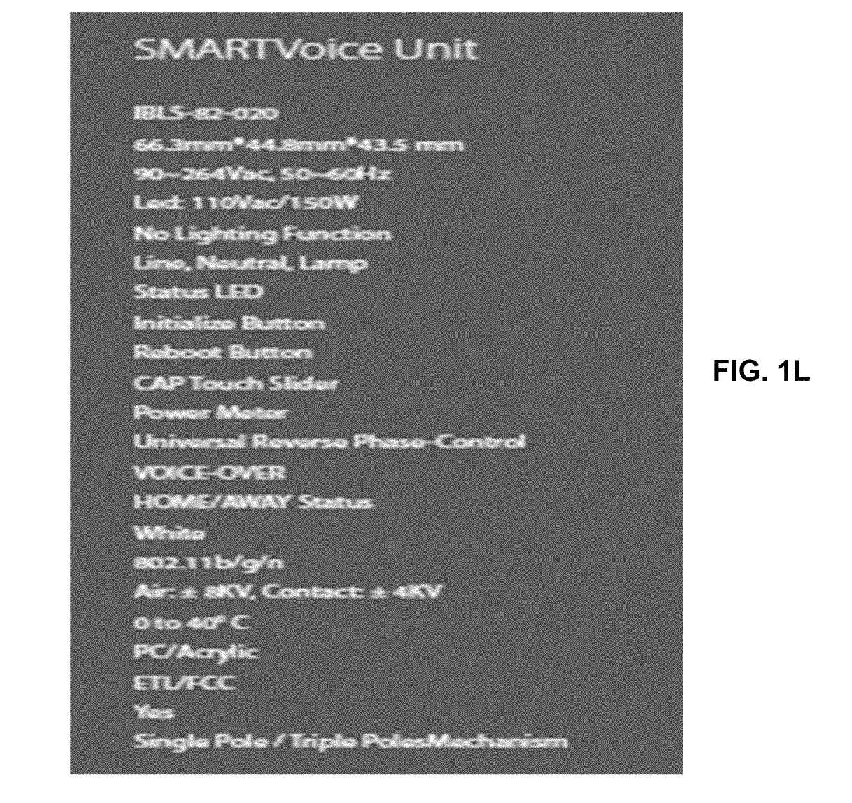

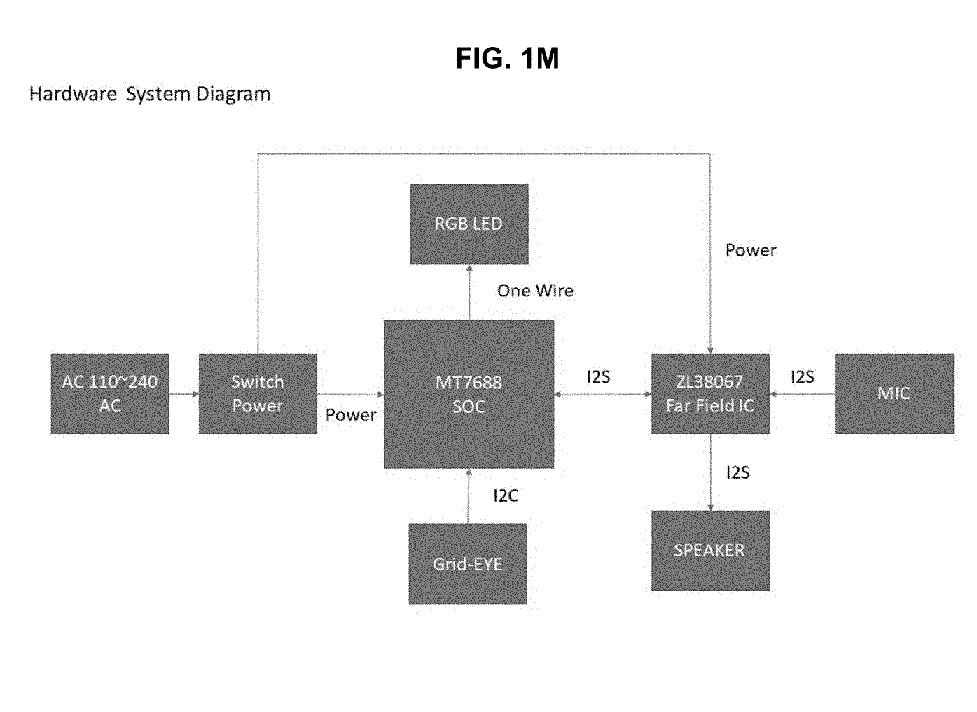

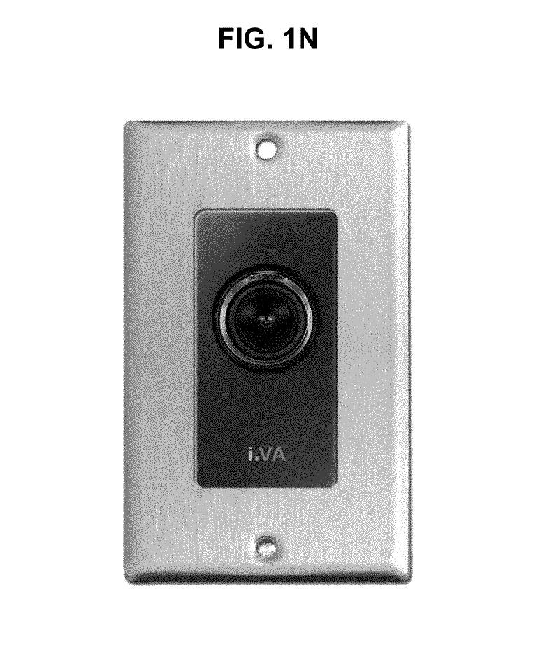

FIGS. 1-12 illustrate embodiments of an Internet of Things (IoT), climate control, and communication system of the teachings of the present disclosure.

As illustrated in FIG. 1A, according to teachings of the present disclosure, generally, the IoT, climate control, and communication system, or IoT communication system, 10 may include a home gateway device 130 which receives signals, data and commands from a network 11, such as the Internet via a cable/DSL based network (via modem 13) and a cellular-based wireless network, and transmits signals, data and commands to devices in a home or building. The home gateway device 130 may also be referred to herein as “home gateway,” “gateway”, “event center,” “home hub,” or “home IoT center control unit.” The home gateway 130 also receives signals, data and commands from devices in a home or building and transmits signals, data and commands to the network 11. The devices in a home or building may include, for example, televisions (TVs) 12, data modem 13, mesh node 14, zone wall plug 15, smart outlet 16, voice control light switch 17, computer 19, appliances 160, and so on. The voice control light switch is described further in FIGS. 1F-1H. In some embodiments, the signals received by and transmitted from the home gateway may be wired signals, for example, cable and DSL, and wireless signals, for example, Wi-Fi and 4G LTE.

The home gateway 130 may receive TV broadcast signals from TV broadcast stations or head-ends, convert the signals and transmit the converted signals for displayed at TV sets 12. In this capacity, the home gateway 130 may function equivalent to a TV set-top box (STB) and/or a digital video recorder (DVR). The home gateway 130 may also receive broadband data signals from an Internet Service Provider (ISP), converts the signals and transmits the converted signals to a mesh node 14, or an Ethernet router. Although not shown, the home gateway 130 may also function as a cable or Digital Subscriber Line (DSL) modem.

FIG. 1B illustrates another exemplary set up of the IoT, climate control, and communication system 100A. Generally, the IoT, climate control, and communication system 100A may include a home gateway device 130 which receives signals from a network 11, such as the Internet and/or a cellular-based wireless network, and transmits signals to devices in a home or building. The home gateway 130 also receives signals from devices in a home or building and transmits signals to the network 11. The devices in a home or building may include televisions (TVs) 12, data modem 13, repeater 140, camera 150, appliances 160, lighting 170, zone devices 18 for controlling heating, venting and/or air conditioning (“HVAC”) units, and so on. In some embodiments, the signals received by and transmitted from the home gateway are wireless signals, including for example, Wi-Fi and LTE 4G.

In some embodiments, the IoT, climate control, and communication system may also include a control device installed at, and for controlling a heating, venting and/or air conditioning (“HVAC”) unit. This HVAC control device 18 may communicate with a HVAC zone device 15, the home gateway 130, and a cloud based management system. The HVAC zone device 18 may include a sensor, for example, a temperature sensor, for sensing the temperature of a residential or commercial zone. A user may use a mobile application or the home gateway to manage the temperature of a selected zone.

FIG. 1B-1 illustrates another exemplary set up of the IoT, climate control, and communication system 100B. Generally, system 100B may include system and devices illustrated in FIG. 1A (system 10) and FIG. 1B (system 100A). Additionally, system 100B may also include an intelligent voice assistant device 110B. In some embodiments, the intelligent voice assistant device 110B may communicate directly with other devices and smart devices, for example, a smart light switch/dimmer, a smart thermostat, an entertainment device (RF/IR transmitter, etc. In some embodiments, the intelligent voice assistant device 110B may communicate with the other devices and smart devices via the home gateway 130 (not shown). In one exemplary aspect, the intelligent voice assistant device 110B may include microphone 115B, a speaker 120B, and a motion sensor 125B. The microphone 115B receives voice commands, for example, from a user, to control other devices. For example, the user can speak to the intelligent voice assistant device 110B to send commands to a smart thermostat to control and manage home climate (temperature). In other examples, the user can speak to the intelligent voice assistant device 110B to send commands to smart light switches, smart outlets (receptacles), home entertainment device and program, smart garage door control device, and the in-home intercom. The intelligent voice assistant device 110B may receive responses and output sounds through speaker 120B.

In some embodiments, upgrades and new features can be downloaded or uploaded to the intelligent voice assistant device 110B. In some embodiments, the intelligent voice assistant device 110B may self-upgrade.

It should also be noted that the systems of the present disclosure may download or upload upgrades and new features to the various smart home devices described herein. The various smart home devices may also self-upgrade.

In some embodiments, the intelligent voice assistant device 110B may support personalized voice recognition. In this aspect, the intelligent voice assistant device 110B may be set up to accept commands only from authorized (recognized) users.

It should be noted that the intelligent voice assistant device 110B may be coupled with the artificial intelligent system of the present disclosure as described further below. In this aspect, a user can ask questions about statuses of devices in the smart home, as well as outside information such as the weather, traffic, etc.

In some embodiments, the intelligent voice assistant device 110B may include motion sensor 125B. The motion sensor 125B detects motion and reports, pushes alert to the user, for example, via an application on a smart phone. In one example, the user may set up an “AWAY” status in the smart home (described further below), the motion sensor 125B and the microphone 115B can detect motion or sound in the house and push alerts to the user.

In FIG. 1B-2, the intelligent voice assistant device 110B may communicate with a router or gateway to send commands or receive responses. It should be noted that the router or gateway may first send data to the cloud or the Internet, and receive data from the cloud or the Internet, then to the various connected smart home devices.

As described herein and shown in FIG. 1B-3, the smart home system may provide the ability for the users to use an application program in a portable device, such as a smart phone, to use voice commands to control and manage the various smart home devices from the smart phone.

FIG. 1C illustrates a system view of one exemplary embodiment of an IoT, climate control and communication system 100C of the teachings of the present disclosure. The IoT, climate control and communication system 100C generally includes HVAC control devices 141, 151, 153 installed at respective HVAC units 140, 150, 152. The HVAC control device may be a machine-to-machine (“M2M”) device and may be coupled to the HVAC unit through 24-volt wiring, or any suitable wiring. The HVAC control device may further include a wireless communication module supporting one or more wireless technology known in the art, for example, 3G, LTE or Wi-Fi. The HVAC control device 141, 151, 153 may communicate wirelessly with a zone device 144. 154, for example, via a Wi-Fi network. The HVAC control device 141, 151, 153 may also communicate wirelessly with a cloud based management system 160, for example, via a cellular network (e.g., 3G, 4G, LTE, and the like). In some embodiments, the HVAC control device 141, 151, 153 may receive control commands from the cloud management system 160 (e.g., via a cellular network, or the Internet).

The HVAC zone device 144, 154 may include temperature sensor to detect the temperature of a zone. A zone is a geographic area within a residence or a business or commercial facility (e.g., a room, a floor, or the like). A residence or a business or commercial facility may include more than one zone. Each zone may have one installed zone device. In some embodiments, each zone may include more than one HVAC system. For example, as shown in FIG. 1C, the zone device 144 is installed in zone A, and detects temperature in zone A. Zone A includes one HVAC system 140 which has HVAC control device 141 installed thereon. The zone device 154 is installed in zone B, and detects temperature in zone B. Zone B includes HVAC systems 150 and 152 which have HVAC control devices 151 and 152 installed thereon respectively. Both zone A and zone B may be located within, for example, a residence (or a commercial building) H. The zone device 144, 154 may transmit the detected temperature to the HVAC control device 141, 151, 153 respectively, to the home gateway 130 (e.g., via a Wi-Fi network), and to the cloud management system 160 (e.g., via the Internet or a cellular network). The zone device 144, 154 may have a display to display the detected temperature and other information. As described herein, a zone device may manage, for example, wirelessly, the HVAC system(s) within its zone.

The home gateway 130 may provide user interfaces for managing the HVAC control devices 141, 151, 153. A user may provide temperature settings using one or more user interfaces. In some embodiments, the home gateway 130 may communicate with and provide control for the HVAC control devices 141, 151, 153, either directly or via the zone devices 144, 154. The home gateway 130 may also send temperature data and user settings to the cloud management system 160.

The cloud management system 160 may receive, and store, data from the HVAC control devices 141, 151, 153, and the home gateway 130. The cloud management system 160 may provide analytic data, manage the temperature management experience and behavioral data based on each individual temperature management decision experience received from the HVAC control devices. For example, the cloud management system 160 may provide data learned from the time of day and the corresponding temperature setting a user selects, with or without specific user programming. Other learned data is also contemplated. The system may provide real time backup of its configuration, device information, and energy usage consumption data. All data of the household may be safely backed up in the cloud. If the homeowner ever decides to move from one house to another, he or she can bring the data with him/her.

In some embodiments, the IoT communication system may provide a voice assistance feature to support the smart home devices, such as smart light switch, smart dimmers, etc. For example, the IoT communication system may include a smart lighting control system built with high quality microphone detection sensor allowing people to use voice to control their ideal home lighting, temperature climate, etc., from anywhere in the house. In these embodiments, although still optional, no other voice assistant device may be needed.

In some embodiments, the voice assistance feature may include a mobile app allowing the user to utilize the mobile phone, from any remote location, to voice control for example, a smart thermostat while the user is not around the house. For example, the user may simply run the mobile app and say “heat on 75 degree”. The smart thermostat will turn on the heat to 75 degree. In another example, the user may remotely shut off the HVAC system if the user had forgotten to turn off the thermostat.

In some exemplary operations, a smart thermostat may be pre-set to 70 F economic energy conservation temperature that follows with a default schedule to turn off at 8:30 am and back on at 5:30 pm from Monday to Friday, and stay for 70 F on Saturday and Sunday. The user can adjust the temperature and schedule by using mobile and web app for his/her own preferences, or disable the smart temperature system.

In some embodiments, one or more machine learning algorithms (Smart Temperature machine learning feature) may learn an ideal house temperature and use-behavior, and automatically adjust the setting, for example in a smart thermostat. In some embodiments, when the user disables the Smart Temperature machine learning feature, the system will stop using the learning algorithms. In some embodiments, the Smart Temperature feature may see the user's mobile phone location to determine if the user is home or away from home. After the mobile app detects the user being away from home, the feature may shut down the HVAC system in, for example, 30 minutes, and send the user an alert message that the home thermostat is shutting down.

In some embodiments, with a Smart Touch Dimmer and Touch Sensitive Pads, the user can turn on, off, or dim incandescent or dimmable CFL light bulbs. Together with the smart thermostat the user can control lighting wirelessly, create custom operation schedules based on personal preferences. The smart dimmer may support Zigbee HA Profile with energy metering that can be seen in real time the energy consumption of the connected light bulbs with ±0.5% accuracy.

In some embodiments, a user may use a mobile application (“mobile app”) 122 installed on a user device 120 to manage the temperature at a selected zone. The user device 120 may include, for example, desktop computer, laptop, tablet, or any mobile or wearable device having a communication interface known in the art.

In some embodiments, the home gateway 130 may also provide media applications such as news, music, movie, parenting management, and so on. The home gateway 130 may provide these functions and services via the cloud management system 160. In some embodiments, the media applications may take advantage of the analytic data collected and managed at the cloud management system 160, for example, to provide the media information suitable to the user.

In some embodiments, the home gateway 130 may provide voice and data communications features. The communications may include nationwide call, text messaging, video call, eFax, and so on. The communications may be managed by the cloud management system 160, and coupled with the mobile app 122. The communications provided may be implemented using technologies known in the art, for example, Voice over IP. The communications may be provided by a single entity, or through collaboration with other commercial telephone operators, for example, AT&T™, T-Mobile™, Verizon™, and so on.

In one exemplary operation of the IoT, climate control, and communication system, a caller may call the home gateway 130. The home gateway 130 may communicate with the cloud management system 160, and alert the associated mobile app 122 to inform the user (intended called party) of the incoming call. The user may decide to take the call or cancel. The user may answer the call from anywhere with the mobile device 120.

The cloud management system 160 may provide other calling features known in the art, for example, call forwarding, voice mail, and so on. The cloud management system 160 may also provide call record keeping and billing functions.

The mobile app 122 may include user interfaces for managing the voice and video communications.

FIG. 1D illustrates an exemplary set up and user interface 180 of the IoT, climate control, and communication system 100(A-C). As shown, the system 100A may support a plurality of smart devices, for example, smart dimmer switch, smart garage door control, smart outlet, smart thermostat 182, etc.

Another exemplary smart device may include smart temperature thermostat device (ThermoRing) 182. As illustrated in FIG. 1E-1, an exemplary smart thermostat 182 may have a thermostat control experience design with all necessary control functions, and may take the design of retro volume knob for the most user-friendly control experience. The smart thermostat 182 may interface with (connect to) a corresponding mobile app and integrate with a voice assistant app or device, for example, Amazon's Alexa™ voice assistant. In some embodiments, the smart thermostat 182 may also have built-in machine learning algorithms helping the users set up the best energy efficient temperature environment. In some embodiments, the machine learning algorithms may be located in the cloud. In some embodiments, a motion sensor 183 of the smart thermostat may detect human body when a person is near the device, and automatically lights up the temperature display so the person can see the current house temperature. In some embodiments, a motion sensor 183 of the smart thermostat may detect human body temperature. In some embodiments, the smart thermostat 182 may turn off the system and set the system idle as energy conversation feature in a preset time, for example, 30 seconds when there is no people around.

In some embodiments, the smart thermostat may also synchronize with other smart home devices such as the smart wall plug's temperature sensor as the second source in house temperature and power consumption metering for a HVAC system.

FIG. 1E-2 illustrates an exemplary high-level schematic diagram of a smart thermostat of the IoT, climate control, and communication system of the present disclosure. In some embodiments, the smart thermostat 182 may connect wirelessly to a wide area network and to an wireless local area network (“IoT LAN”), wherein the wide area network may be a cellular network and the wireless local area network is distinct from a second wireless local area network, which may be a residential consumer Wi-Fi network. In this set up, even if the home or building loses the residential Wi-Fi network, the smart thermostat 182 can still connect to and communicate with the plurality of smart home devices on the IoT LAN. The narrowband (NB) module component 184 may provide hot-spot connection to the cellular network or to the Internet. The Wi-Fi module component 185 may provide connection to the IoT LAN.

FIG. 1E-3 illustrates an exemplary Wi-Fi IoT LAN network in a house. Although FIG. 1E-3 shows connection among a few devices, all smart home devices may be connected to the IoT LAN.

It should be noted that although the IoT LAN is disclosed as controlled by the smart thermostat, other smart home devices of the present disclosure may also include a narrow band module 184 and Wi-Fi module 185. In these embodiments, a smart home device with both modules 184 and 185 may be configured provide direct access to the wide area network (cellular network) and the IoT LAN. In some embodiments, the narrow band module may be or may include a broadband module (for example as in some embodiments of the home gateway 130).

FIG. 1F illustrates an exemplary view of a Smart Touch Dimmer, also referred herein as Smart Switch or Smart IoT Voice Light Switch. In some embodiments, the Smart Switch may include one or more microphones, and one or motion sensors. Other sensors and speakers may also be included. The Smart Switch may also include antenna, other hardware and software for wirelessly connecting to an Internet router, and/or to the home gateway 130. This enables the Smart Switch to communicate with the cloud management system 160. The motion sensor, or detector, may detect movement (e.g., human movement) in the vicinity of the Smart Switch. Upon detection, the Smart Switch may activate the microphone(s).

The Smart Switch may have AWAY and HOME status, if the status is set for AWAY, once the microphone and/or motion sensor detects sound and/or movement, the system will send out alert message to a mobile app or to security company as set up. In some embodiments, the Smart Switch may be integrated with an intelligent security alert system in the cloud management system.

A Smart Switch application (e.g., mobile app) may be provided for use with smart devices such as smart phones (e.g., iPhone), tablets (e.g., iPad), and others (see also FIG. 1H). A user may use the software (mobile app) to setup microphone status, e.g., as always on, schedule on or off at certain time of the day, or always off. The software may also allow the user to setup a group of devices, e.g., one voice command may operate with many smart devices as the same time. In this manner, as an example, the user may use the Smart Switch as the voice bridge between all the other smart IoT devices, such as the smart thermostat, smart electric outlets and other smart device or system (see FIG. 1G). In other examples, the user can use the Smart Switch voice system to control a smart TV and select ideal TV program, or turn the TV volume up and down, or control IP camera feed.

The user may also use the software to set up the Smart Switch for single pole or triple pole setup. The user may use voice command to setup smart system for “HOME” or “AWAY” as described above.

In some exemplary operations, when the user walks in the house, he can speak to a Smartt Switch at or near the door, e.g., “ibright, this is Max, I am home,” to set up HOME status (“ibright” is an exemplary name given to the Smart Switch in this example). The Smart Switch's LED may flash to confirm voice command received successfully. Or before leaving the house, the user may command the Smart switch with voice as: “ibright, this is Max, I am away,” to set up the AWAY status. In another exemplary operation, when the cloud management system has been set with the AWAY status, with any sound or movement detected by the Smart Switch, the cloud management system will send out alert to the mobile app to inform the user that there is movement in the house.

In some embodiments, the mobile application may use location detection features to detect if the user is HOME or AWAY.

In some embodiments, if there are multiple users (e.g., household members) registered with the system, just one member is away/home, it will not execute the smart alert system, until the last member command away/home is executed.

FIG. 1G illustrates an exemplary voice command connection and operation among the Smart Switch, the home gateway and the cloud management system. As described, the voice command may also act as voice bridge between all the other smart IoT devices.

FIG. 1H illustrates an exemplary operation of the application as a mobile app on a smart phone.

In some embodiments, the system's Smart Duplex Outlets may allow wireless control of appliances or other electronic devices. Together with the Smart Thermostat, the user can monitor energy consumption using ZigBee Wireless radio which is compatible with Home Automation profile and custom energy metering.

FIG. 1I illustrates an exemplary front view of an intelligent voice assistant device. The intelligent voice assistant device may include a HD microphone, an AI speaker, a motion sensor, an LED voice status, and an online LED status. The microphone receives voice commands, for example, from a user, to control other devices disclosed in the present disclosure. The intelligent voice assistant device receives responses and outputs sound through the speaker. (See also FIG. 1B-1) FIG. 1I shows the intelligent voice assistant device as a wall-mount unit. But it may also be in other form. In some embodiments, a user may speak into the intelligent voice assistant device to direct voice command through a wireless network, or the Internet, to other smart home devices. For example, the user may direct command to a smart light switch, saying, “Hi [optional voice agent name], turn on living room [device name],” or “Turn kitchen light to 70%.” In another example, the user may direct command to a smart thermostat, saying, “Set temperature 68 degree.”

In some embodiments, the intelligent voice assistant device may include a motion sensor. In one example, the user may set up a HOME or AWAY status in the smart home (as described above with the smart light switch), the motion sensor and the microphone can detect motion or sound in the house and, in the case of AWAY status, can push alerts to the user.

FIG. 1J illustrates an exemplary high-level block diagram of a smart home system having an intelligent voice assistant device 190 (shown as “IVA”). As shown, the IVA may be coupled to a voice system 192, a cloud network 194, and other Wi-Fi devices 196.

FIG. 1K illustrates an exemplary high-level block diagram of a smart home system having an intelligent voice assistant device (shown as “IVA”) coupled to a home management device, e.g., the home gateway 130. As described above, through the home management device, the IVA can communicate with other devices in the home, e.g., smart thermostat, smart light switches, smart outlets, etc.

FIG. 1L illustrates an exemplary list of features and components of the intelligent voice assistant device, shown as SMARTVoice Unit.

FIG. 1M illustrates an exemplary high-level block diagram of hardware components of an intelligent voice assistant device.

FIG. 1N illustrates an exemplary front view on a wall-mount smart home camera device of the smart home. In some embodiments, the camera may be an IP camera installation without AC adapter. In this embodiment, the embedded IP camera with wi-fi connection may be designed into a single gang light switch in-wall enclosure to solve the power issue with AC adapter. The IP camera can take still photos as well as video. Like the camera 150, the IP camera can be coupled to the home gateway 130, and the other devices described in the present disclosure.

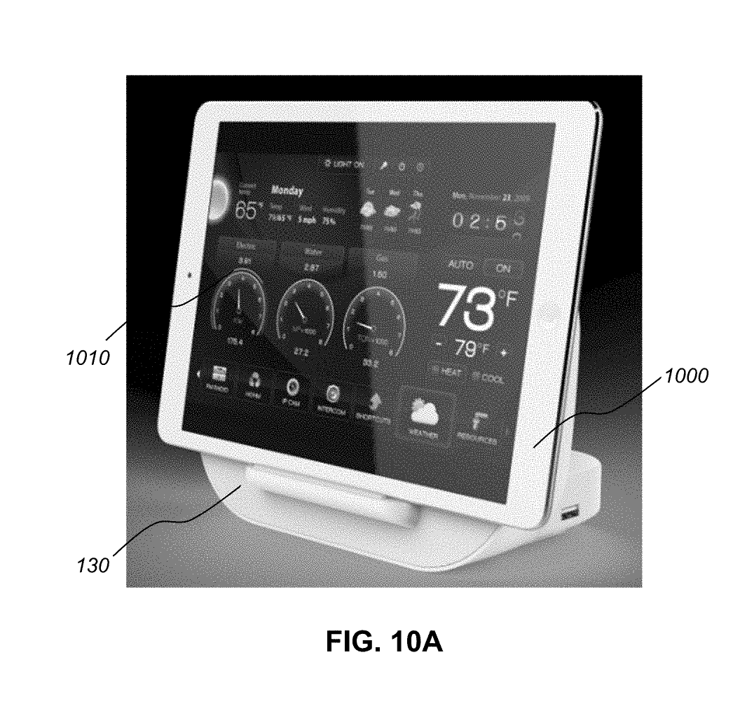

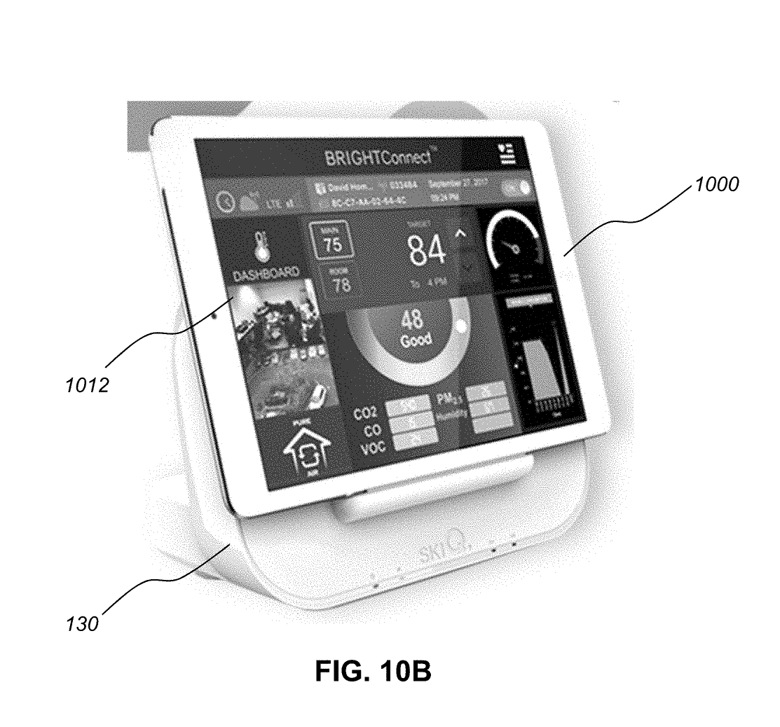

Turning to FIG. 2 and FIG. 3, FIG. 2 illustrates a front perspective view of an exemplary home gateway 130, FIG. 3 illustrates a rear perspective view of the exemplary home gateway 130, according to the teachings of the present disclosure. The home gateway 130 may include an upright main body 210, and a base 220. In some embodiments, the main body 210 may slant backwardly. The main body 210 may include a flange 230 extending outwardly from the lower front portion of the main body 210. A mobile device, for example, a tablet, may be advantageously placed on the flange 230 and rested against the main body 210 (see, for example, FIGS. 10A and 10B). The main body 210 may be in the shape of a substantially rectangular ring with rounded edges. In some embodiments, the inner border 212 of the main body 210 may be made of transparent material so that LED lights may be positioned inside the main body 210 may project light through the inner border 212 and be visible. The LED lights may have different light colors that can be programmed to change, or to be changed by a control device.

The base 220 may include electronics that will be described further herein. The rear panel 222 of the base 220 may include one or more interfaces. These interfaces may include, for example, one or more 10/100/1000BASE-T Ethernet network interfaces (RJ-45 in/out), one or more Universal Serial Bus (USB) interfaces (e.g., USB 2.0, USB 3.0), one or more HDMI interfaces (e.g., HDMI 2.0), and so on. The panel 222 may also include LED lights (e.g., with three colors) may be used as visual indicators for system and radio status, a reset button, and a power connector. Other interfaces and connectors are also contemplated. The side panel 224 of the base 220 may also include one or more interfaces, for example, USB interfaces, HDMI interfaces, and so on.

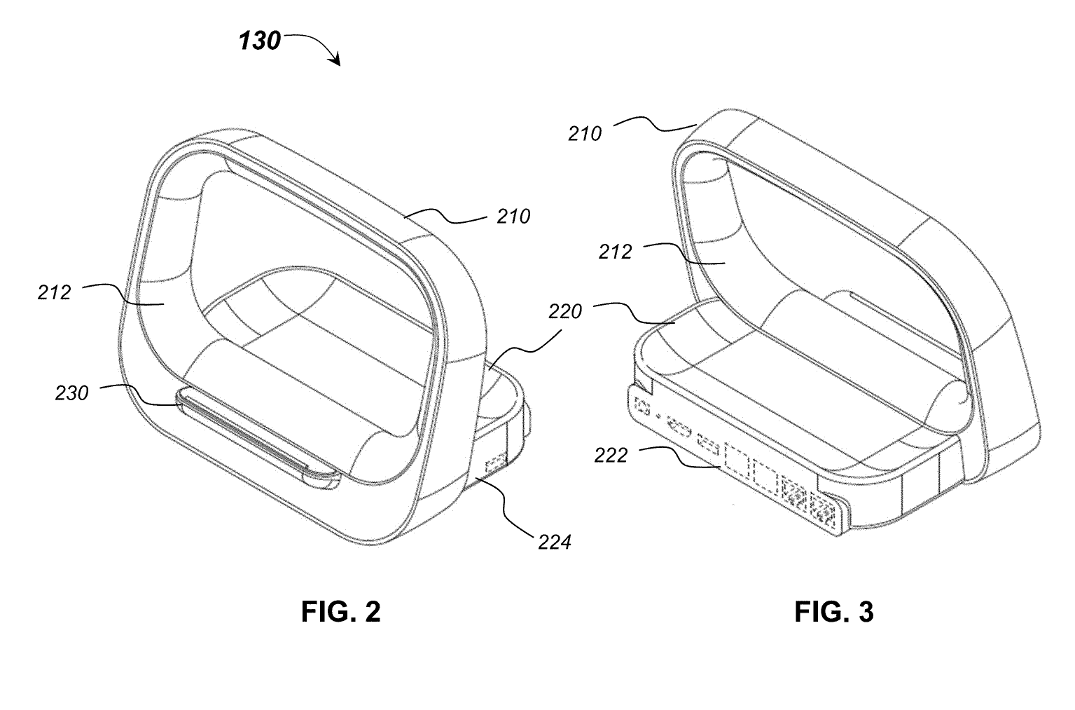

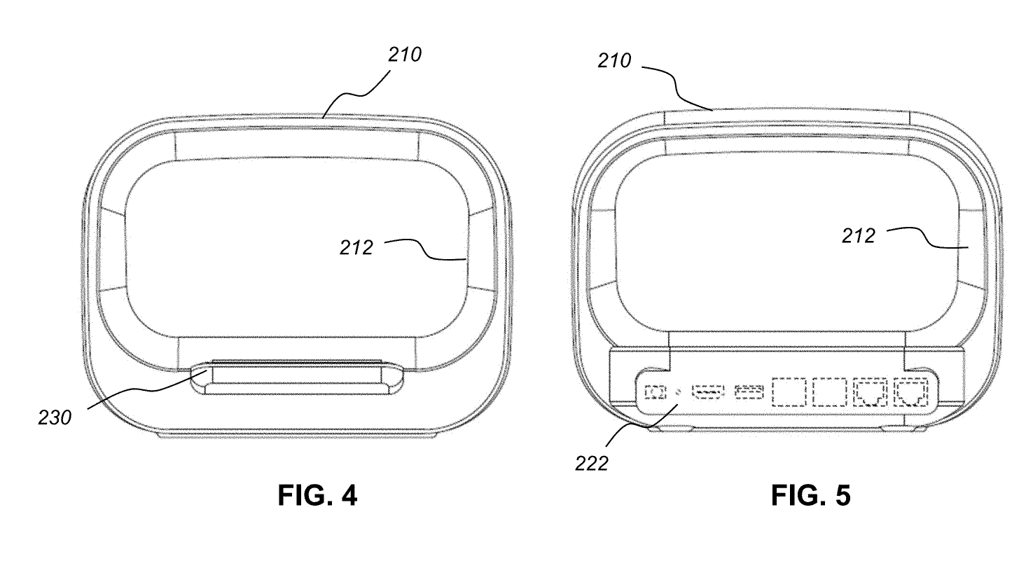

FIG. 4 illustrates a front view of the exemplary home gateway 130, according to the teachings of the present disclosure. FIG. 5 illustrates a rear view of the exemplary home gateway 130, according to the teachings of the present disclosure.

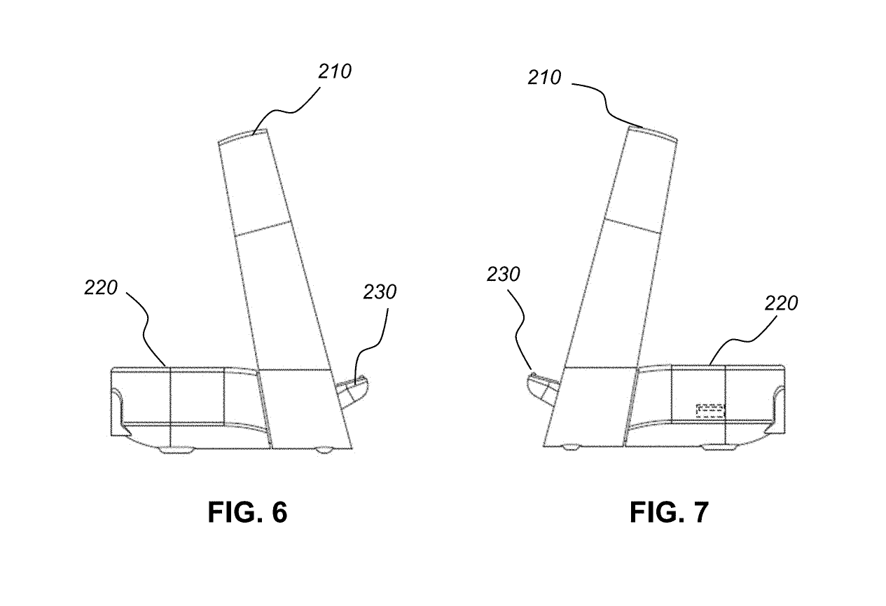

FIG. 6 illustrates a left side view of the exemplary home gateway 130, according to the teachings of the present disclosure. FIG. 7 illustrates a right side view of the exemplary home gateway 130, according to the teachings of the present disclosure.

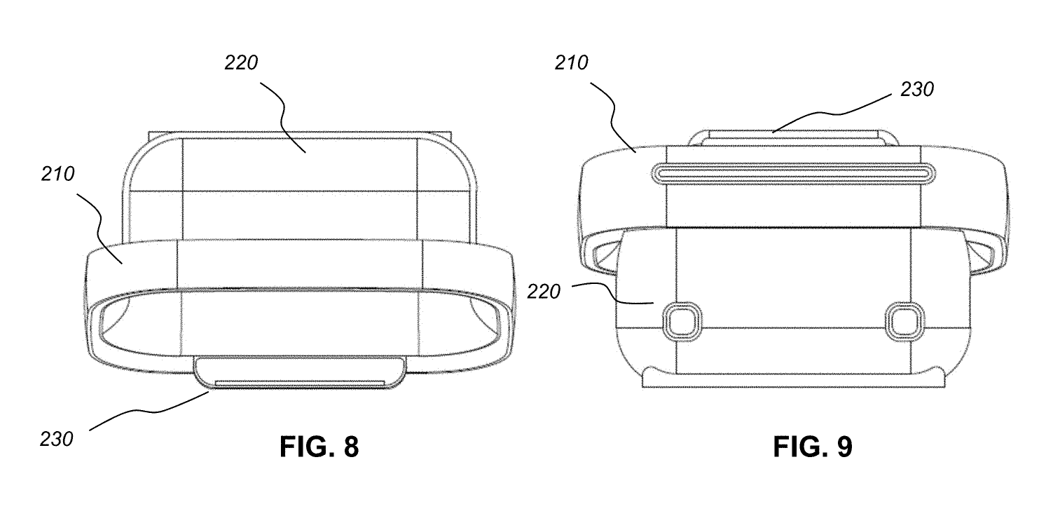

FIG. 8 illustrates a top view of the exemplary home gateway 130, according to the teachings of the present disclosure. FIG. 9 illustrates a bottom view of the exemplary home gateway 130, according to the teachings of the present disclosure.

FIGS. 10A and 10B illustrate perspective views of the exemplary home gateway 130 receiving, or connecting to or combined with, a mobile device 1000, according to the teachings of the present disclosure. Although the mobile device 1000 is shown as a tablet (e.g., an iPad), it may also be a smart phone, a laptop, a desktop computer, or any mobile or wearable device having a communication interface known in the art. In some embodiments, the mobile device may be connected to the home gateway 130 via a USB connector. In other embodiments, the mobile device 1000 may be connected to the home gateway 130 via a wireless network, for example Wi-Fi, Bluetooth, etc. The mobile device 1000 may include software applications to control and operate the functions of the home gateway 130. These functions may include, for example, temperature control, appliance control, lighting control, utility/energy control, mobile TV, video control, security control, and so on. The software applications may include a plurality of user interfaces 1010 (only one example of which is shown) that allow the end users the ability to use the home gateway 130 and the various functions of the software applications. The user interfaces 1010 and 1012 (in FIGS. 10A and 10B) may provide direct control of the connected home devices, and statuses of and reports from the home devices.

In some embodiments, the home gateway 130 may be connected to one or more service providers via a wireless network or via the Internet. The service provider may be, for example, an entertainment service provider, DirectTV, and the like. In these embodiments, the home gateway 130 is connected to and interacts with one or more servers at the service provider to bring entertainment data from the service provider to end user devices such as TVs, mobile devices, etc., via cable connection (e.g., HDMI) or wireless connection (e.g., Wi-Fi or Bluetooth) between the home gateway 130 and the end user devices. A server may be distributed on one or more physical servers, each having processor(s), memory, an operating system, and input/output interface, and a network interface all known in the art, or may be a logical server, or the cloud.

In some embodiments, the home gateway 130 may include wireless communications both on the network side and on the premise side. The wireless communications may include Wi-Fi and LTE. The home gateway 130 may support Wi-Fi standards known in the art, for example, 802.11(a/g/n/ac), 2.4G and 5G bands, with one or more Wi-Fi antennas integrated in the main body 210. The Wi-Fi antennas may support standards known in the art, for example, 3×3 or 4×4 MIMO antennas. The home gateway 130 may support cellular standards known in the art, for example, 3G and 4G LTE (and newer standards when available and adapted, such as 5G), with one or more cellular antennas integrated in the main body 210. The cellular antennas may support standards known in the art, for example, 3G and 4G LTE, and newer standards when available and adapted, such as 5G. The home gateway 130 may provide support for a Wi-Fi mesh network within the premise to communicate with the plurality of device types described herein.

In some embodiments, the home gateway 130 may support video broadcasting, for example, TV broadcast. As described herein, home gateway 130 may receive TV broadcast signals from TV broadcast stations or head-ends, convert (e.g., decode) the signals and transmit the converted signals for displayed at end devices, for example, at TV sets or other receiving devices. In these embodiments, the home gateway 130 may receive broadcast signals via Over-the-Top (OTT) platform, and may transmit signals to the end devices using Wi-Fi, HDMI, and/or other suitable interfaces known in the art.

In some embodiments, the home gateway 130 may provide 24/7 redundancy failover Internet connection. The home gateway 130 may be connected to a cable/ADSL modem and subscribe to the cellular Internet data service at the same time. When the home gateway 130 detects the cable/ADSL disconnect with the Internet, the home gateway may switch over to the cellular Internet immediately and automatically, to ensure that the household or building will maintain seamless Internet network connection.

In some embodiments, the home gateway may 130 be designed to be coupled with a consumer tablet, such as iPad, to leverage unlimited and rich apps used for many different applications.

In some embodiments, the home gateway 130 may also provide a mesh network to the premise (house and building) for a better, more robust wireless network connection. In some embodiments, the mesh node may be a wall-plug Wi-Fi range extender that extends the coverage area of a Wi-Fi network to ensure device connectivity. When paired with the home gateway 130, they create a Wi-Fi mesh network with a smart roaming feature that gives connected client devices high data throughput when moving around the coverage area. The unique design of user interface makes it easy to pair with the home gateway 130 and to be placed on an optimum location that maximizes Wi-Fi coverage. In some embodiments, 4 mesh can be connected together to a home gateway 130. A higher capacity is also contemplated.

In some embodiments, a mesh node may include these features: simultaneous 2.4 GHz and 5 GHz wireless bands, works with the home gateway 130 for Wi-Fi mesh network, works with any router for range extender function only, repeater and access point operation modes, crossband technology allowing for the simultaneous use of both bands, WPS push-button Wi-Fi connection, and so on. Mesh mode may be the default operation mode, where access point mode may be selected. The mesh node may support IEEE 802.11ac AC1200 dual band 2×2 MIMO (300+866 Mbps), and may include 2 internal dual-band antennas. The mesh node may include a Gigabit Ethernet for backhaul connection. A plurality LED indicators may be provided, for example, Mesh Mode, AP Mode, WPS connection, Wireless on/off, LAN activity, Power, etc.

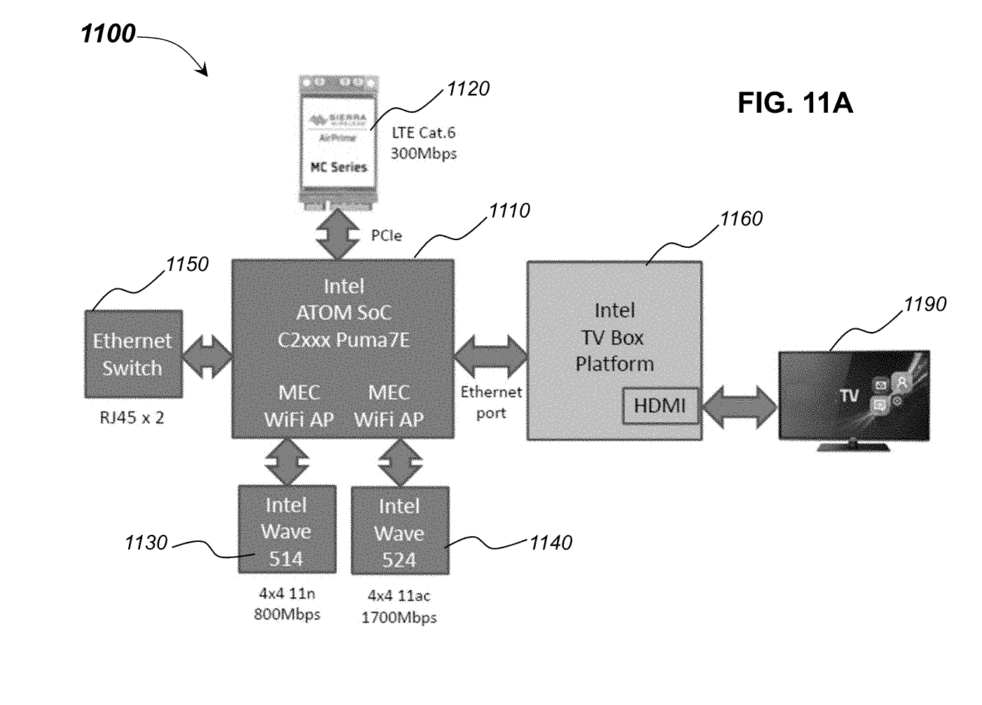

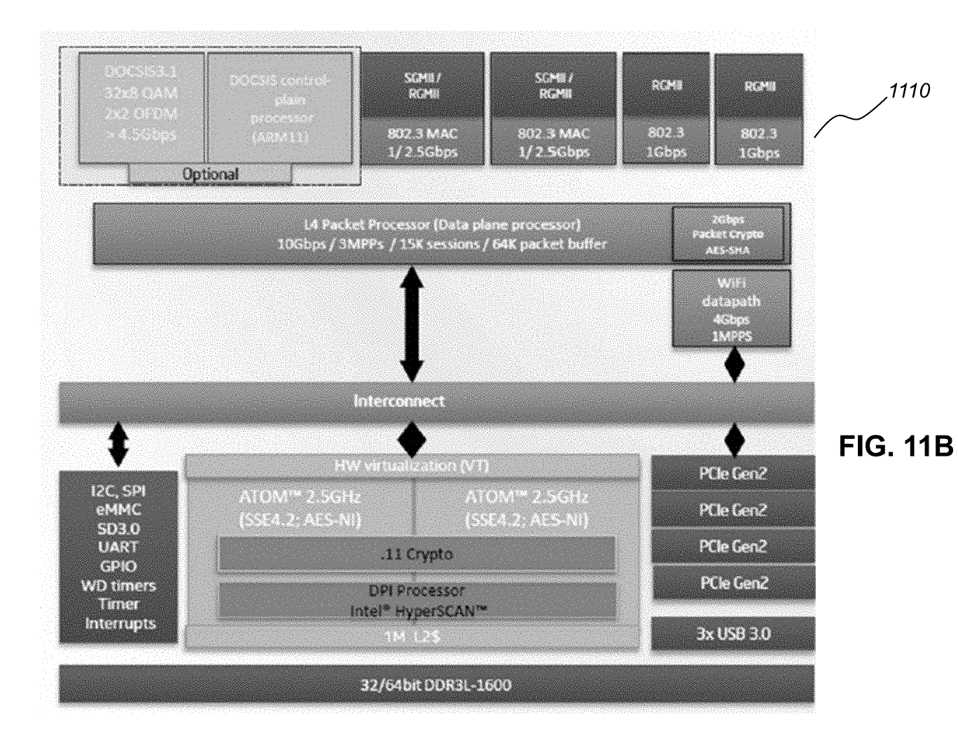

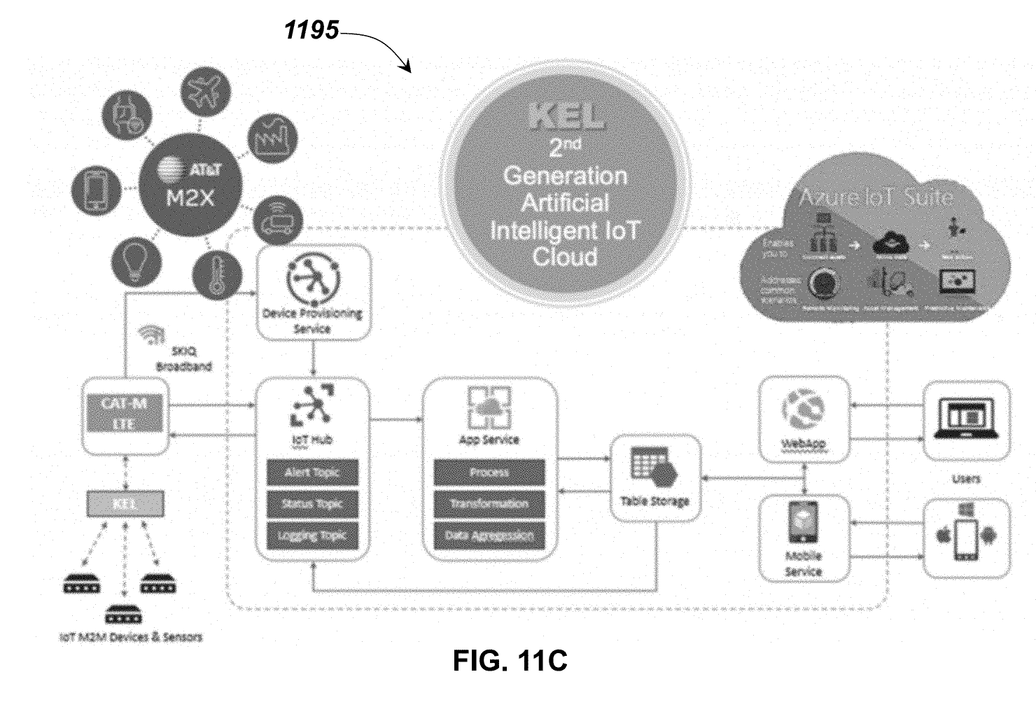

FIG. 11A illustrates a schematic view 1100 of some of the electronics of the exemplary home gateway 130, according to the teachings of the present disclosure. The home gateway may include at least one printed circuit board (PCB) including at least one processor 1110, at least one LTE (e.g., dual bandwidth 4G/LTE Category 6) interface module/modem 1120, one or more Wi-Fi interface modules 1130, 1140, one or more Ethernet switches 1150. In some embodiments, the home gateway 130 may connect with a TV platform device 1160, via, for example, Ethernet connection, to provide cable connection (e.g., HDMI) to one or more TVs. In some embodiments, the home gateway 130 may support 5 Mbps to 300 Mbps data download from the network data Category 6, and SIM data activation.

The home gateway 130 may include storage device and memory, for example, to support DVR functions. The storage device may include at least one solid state drive (SSD) (e.g., 128/256 GB), or the like.

FIG. 11B illustrates a schematic view of the processor 1110 of the exemplary home gateway 130, according to the teachings of the present disclosure.

Turning to FIG. 11C, in some embodiments, the home gateway 130 may also integrate with an artificial intelligence system, to provide functionalities such as indicating the system (home gateway) status, network status, climate or air quality condition, smoke alert, any add-on function of sensor capability, etc.

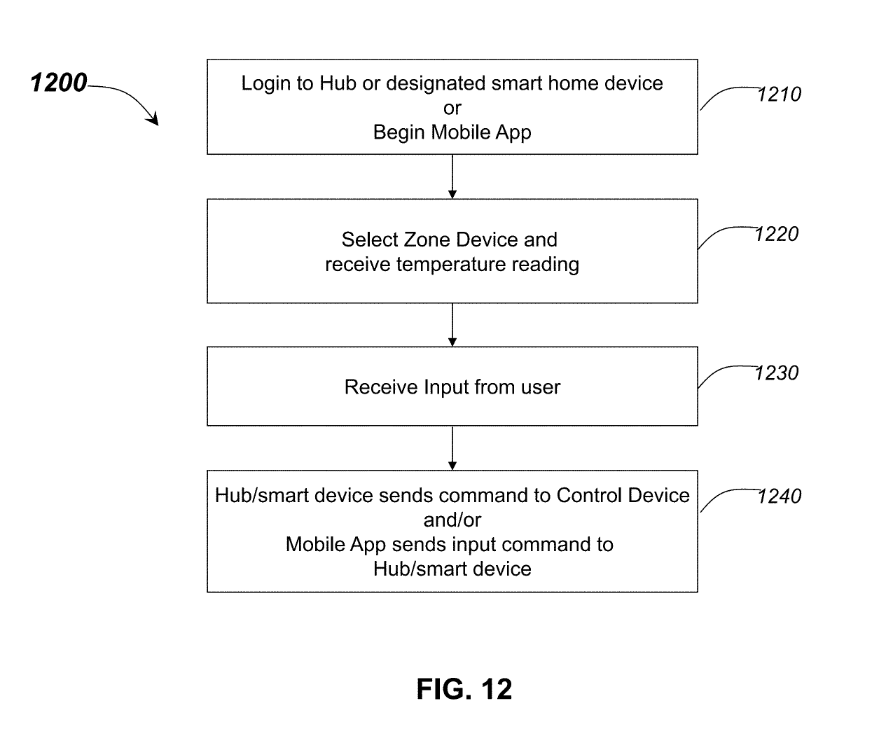

FIG. 12 illustrates an example operation 1200 of the climate control and communication system 100 of the teachings of the present disclosure. A user of the climate control and communication system 100(A-C) may log into a home gateway 130 or a smart home device designated or configured as controlling the smart home devices (Step 1210), select a zone to receive the current temperature reading of the selected zone (Step 1220). Alternatively and additionally, the user may open a mobile app 122 on a user device 120 in connection to the home gateway or designated smart home device (Step 1210), select a zone to receive the current temperature reading of the selected zone (Step 1220). The user may then set a desired temperature for the zone (Step 1230). If the user logged into the home gateway 130 for smart home device (at Step 1210) to enter the desired temperature, the home gateway 130 or smart device sends control command to the HVAC control device(s) within the selected zone to instruct the HVAC control device(s) to control the temperature at the respective HVAC system(s). If the user opened a mobile app 122 on a user device 120 (at Step 1210) to enter the desired temperature, the mobile app 122 sends control command to the home gateway 130 or smart home device which then sends control command to the HVAC control device(s) within the selected zone to instruct the control device(s) to control the temperature at the respective HVAC system(s).

In some embodiments, the mobile app 122 may be set up by scanning a bar code. The information may be sent to the cloud management system 160, which downloads setup information to the user device 120.

Various features and components have been disclosed for some particular smart home devices. However, it is to be understood and appreciated that these features and components may also be provided in other smart home devices of the present disclosure.

Various aspects have been presented in terms of systems that may include several components, modules, and the like. It is to be understood and appreciated that the various systems may include additional components, modules, etc. and/or may not include all the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

In addition, the various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Operational aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

Furthermore, the one or more versions may be implemented as a method, apparatus, or article of manufacture using standard programming and/or engineering techniques to produce software, firmware, hardware, or any combination thereof to control a computer to implement the disclosed aspects. Non-transitory computer readable media can include but are not limited to magnetic storage devices (e.g., hard disk, floppy disk, magnetic strips . . . ), optical disks (e.g., compact disk (CD), digital versatile disk (DVD), BluRay™ . . . ), smart cards, solid-state devices (SSDs), and flash memory devices (e.g., card, stick). Of course, those skilled in the art will recognize many modifications may be made to this configuration without departing from the scope of the disclosed aspects. In general, terms such as “coupled to,” and “configured for coupling to,” and “secured to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

Although the previous description illustrates particular examples of various implementations, the present disclosure is not limited to the foregoing illustrative examples. A person skilled in the art is aware that the disclosure as defined by the appended claims and their equivalents can be applied in various further implementations and modifications. In particular, a combination of the various features of the described implementations is possible, as far as these features are not in contradiction with each other. Accordingly, the foregoing description of implementations has been presented for purposes of illustration and description. Modifications and variations are possible in light of the above description.

What is claimed is:

1. An Internet of Things (IoT) communication system, comprising:
a first smart home device wirelessly connected to a wide area network and a first wireless local area network, wherein the wide area network is a cellular network and the first wireless local area network is distinct from a second wireless local area network;
a plurality of second smart home devices wirelessly connected to the first smart home device via the first wireless local area network; and
wherein the plurality of second smart home devices comprises at least one of: a mesh node, an access point, a television (TV), a data modem, a repeater, a camera, an appliance, a smart lighting unit, a zone device for controlling one or more heating, venting and air conditioning (“HVAC”) units.

2. The IoT communication system of claim 1, wherein the first wireless local area network is a closed and secure Wi-Fi network.

3. The IoT communication system of claim 1, wherein the second wireless local area network is a residential Wi-Fi network.

4. The IoT communication system of claim 1, wherein the first smart home device comprises a Subscriber Identity Module (SIM) card and a Wi-Fi controller.

5. The IoT communication system of claim 1, wherein the first smart home device is further configured as a Wi-Fi router.

6. The IoT communication system of claim 1 further comprises a cloud based management system communicatively connected to the plurality of second smart home devices.

7. The IoT communication system of claim 1, wherein the first smart home device is a smart thermostat.

8. The IoT communication system of claim 7, wherein the smart thermostat further comprises at least one of a motion sensor and a light sensor.

9. The IoT communication system of claim 1, wherein the first smart home device is a home gateway.

10. The IoT communication system of claim 1 further comprises one or more control devices each installed at each of the HVAC unit.

11. The IoT communication system of claim 10 further comprises a cloud based management system configured to receive and store data from the one or more control devices.

12. The IoT communication system of claim 10 further comprises one or more zone devices each configured to control one or more HVAC units in a defined geographic zone.

13. The IoT communication system of claim 12, wherein the each of the one or more zone devices comprises a temperature sensor.

14. The IoT communication system of claim 1, wherein the first smart home device is configured to connect to a mobile device which provides software applications to control the plurality of second smart home devices.

15. The IoT communication system of claim 9, wherein the home gateway is configured to provide broadcast TV signals.

16. The IoT communication system of claim 9, wherein the home gateway is configured to provide Internet connection with failover redundancy.

17. The IoT communication system of claim 1 further comprises an intelligent voice assistant device configured to receive audio input.

18. The IoT communication system of claim 17, wherein the audio input comprises one or more commands to control one or more smart home device of the plurality of second smart home devices.

19. The IoT communication system of claim 17, wherein the intelligent voice assistant device comprises at least one of a microphone, a speaker and a motion sensor.

20. The IoT communication system of claim 1 further comprises machine learning artificial intelligence.
